(19) United States
(12) Patent Application Publication
(10) Pub. No.: US 2026/0209612 A1
(43) Pub. Date: Jul. 23, 2026

(54) PYROLYSIS OIL PURIFICATION USING SUCCESSIVE EXTRACTIONS

(71) Applicant: SABIC Global Technologies B.V., Bergen op Zoom (NL)

(72) Inventors: Fabrice CUOQ, Geleen (NL); Kae Shin WONG, Geleen (NL); Robert C. SCHUCKER, Bangalore (IN); Prasanna R. DASARI, Bangalore (IN)

(73) Assignee: SABIC Global Technologies B.V., Bergen op Zoom (NL)

(21) Appl. No.: 19/140,893

(22) PCT Filed: Dec. 11, 2023
(86) PCT No.: PCT/IB2023/062509

§ 371 Date: Jun. 18, 2025

(30) Foreign Application Priority Data
Dec. 22, 2022 (EP) 22216263.8

(51) Int. Cl. C10G 31/08; B01D 11/04; B01D 17/00; B01D 17/02; B01D 69/02; B01D 71/36; C10G 29/06; C10G 31/09

(52) U.S. Cl. CPC C10G 31/08; B01D 11/0492; B01D 17/02; B01D 17/085; B01D 69/02; B01D 71/36; C10G 29/06; C10G 31/09; B01D 2325/38

(57) ABSTRACT

Systems and processes of purifying waste plastic pyrolysis oil (pyoil) using water based extractions.

### CROSS REFERENCE TO RELATED APPLICATIONS

This application claims the benefit of priority of European Patent Application No. 22216263.8, filed Dec. 22, 2022, which is hereby incorporated by reference in its entirety.

### BACKGROUND OF THE INVENTION

### A. Field of the Invention

The present invention generally relates to systems and processes of purifying waste plastic pyrolysis oil (pyoil) using aqueous based extractions.

### B. Description of Related Art

Plastics are found in industrial and domestic applications. While tons of plastics are produced every day, waste plastics have created serious environmental challenges due to their extremely long natural decomposition process. Thus, various processes for reusing and/or recycling of plastics have been explored in the last few decades.

Pyrolysis of waste mixed plastics is a process that includes decomposing plastics at a high temperature to produce a pyoil. Pyoil can be used directly as a liquid fuel or further processed for producing chemicals of high value. However, pyoil produced from mixed plastics generally contains a substantial amount of highly reactive chemicals, resulting in fast aging of the pyoil and formation of gums during transportation and further processing steps. Hence, it is fairly common for pyoil to foul containers and/or chemical processing units in which it is handled and/or processed with trace oxygen presented therein.

Processes to purify pyrolysis oil are described in U.S. Patent Application Publication No. 20020195315 to Zhang et al., French Patent No. 3119399 to Coustham et al., and U.S. Patent Application Publication No. 20020353276 to Paasikallio et al., each describe extracting waste plastic pyrolysis oil with an organic solvent (e.g., n-methyl-2-pyrrolidone, methanol, ethanol, formic acid, acetic acid, propanoic acid, butanoic acid and pentatonic acid) to lower the contaminant content in the waste plastic pyrolysis oil.

Overall, while systems and methods for treating waste plastic pyoil derived from mixed plastics exist, the need for improvements in this field persists.

### SUMMARY OF THE INVENTION

A discovery has been made that provides a solution to at least one of the aforementioned problems associated with systems and processes of purifying waste plastic pyrolysis oil. In one aspect, the invention can include a process to reduce contaminants (e.g., heteroatom-containing components (e.g., oxygen-containing, organic nitrogen-containing, chloro-containing, etc.) in the waste plastic pyrolysis oil) in waste plastic pyrolysis oil compositions. The process uses successive extractions of the waste pyrolysis oil. The extract composition can include water and/or a base (e.g., sodium hydroxide, potassium hydroxide, aluminum hydroxide, calcium hydroxide, or a combination thereof). In some aspects, the extract composition can include a solvent (e.g., an alcohol). In each extraction, the amount of water can be increased from 1 to 5 percent, preferably about 3 percent. This process provides the advantage of using less organic solvent than a single extraction or multiple extractions using a constant amount of organic solvent. It also provides the advantage of lowering the contaminate content in pyoil as compared to multiple extractions at a constant ratio of raffinate to water and/or organic solvents. This makes treating waste plastic pyrolysis oil of the present invention more efficient, energy efficient and sustainable than organic solvent extraction as it can be used in small processing units and/or mobile units, the extract composition that includes water can be treated using conventional water treatment technology. Use of the base (e.g., caustic) can provide the advantage of removal of organo-chloride esters and/or organo-chloride alcohols through hydrolysis and/or deprotonation reactions.

In one aspect of the invention processes to remove contaminants from a waste plastic pyrolysis oil are described. A process can include a step (a) of extracting a waste plastic pyrolysis oil composition that can include waste plastic pyrolysis oil and contaminants with a first extract composition than can include water and/or a base (e.g., caustic) to produce a first raffinate that includes the waste plastic pyrolysis oil and having less contaminates than the waste plastic pyrolysis oil composition before extraction. A volume ratio of the waste plastic pyrolysis oil to extract medium can be 99:1, preferably 95:5. The process can also include multiple extraction steps. In a second extraction (e.g., step (b)), the first raffinate (e.g., from step (a)) can be extracted with a second extract composition that can include water and/or a base to produce a second raffinate. The second raffinate can include at least a portion of the first raffinate and can have less contaminates than the first raffinate before extracting. In the second extraction, a volume ratio of the first raffinate to second extract medium can be about 98:2 or less preferably about 90:10. The second raffinate can be separated from the second extract composition (e.g., water). The process can also include a third extraction (e.g., step (c)) In the third extraction (e.g., step (c)), the extraction process of the second extraction can be repeated at least 2 times, preferably 3 times or more, more preferably 5 times or more. In each subsequent extraction, the amount of water in each extract composition used for each extraction the water can be increased by 1 percent to 5 percent, preferably about 3 percent. The extraction process can be ended and the final raffinate can be collected. In each extraction, the extract composition (e.g., water) can be separated from the raffinate. The aqueous extract phases can be collected. The final raffinate can include purified oil phase. For each extraction, the extraction temperature can be 20° C. to 150° C. In some aspects, the extract/raffinate phases are an emulsion and the method can include passing the emulsion through a hydrophobic membrane (e.g., a polytetrafluoroethylene membrane) to separate the raffinate (e.g., oil phase) from the extract phase (e.g., water phase). The contaminate content of the final raffinate can be reduced as compared to the contaminate content of the waste plastic pyrolysis oil prior to extraction. The contaminates can include chloride compounds, preferably organic chlorides (e.g., 1,2-dichloroethane, 2-chloroethanol acetate; 2-chloroethanol; 2-(2-chloroethoxy) ethanol; 2-chloroethoxy benzene; 1,2 dichloroethene; 1-chloro-2-ethoxyethane; 2-chloroethylmethylsulfide; 2,3-dichloro-1-propanol; 1,3-dichloro-2-propanol; 1,4-dichlorobutane, bis(2-chloroethyl)-ether; 2-chloroethylbenzoate; or a combination thereof). The chloride content can be reduced by at least 10 wt. %, preferably by at least 15 wt. %. Another contaminate can be oxygenates. The oxygenate content can be lowered by at least 10 wt. %, preferably at least 15 wt. %. Yet another contaminate can be nitrogen compounds. The extraction can lower the nitrogen content by at least 10 wt. %, preferably by at least 15 wt. %. In some aspects, the contaminates can include gum or gum-producing precursors.

In some aspects of the present invention, systems for reducing contaminants in a waste plastic pyrolysis oil are described. The systems can be used to perform the processes of the present invention. A system can include a first mixing unit and a first separation unit. The first mixing unit can be capable of receiving waste plastic pyrolysis oil and the first extract composition that includes water and/or a base and producing a first dispersion comprising the waste plastic pyrolysis oil and the extract composition. In some aspects, the first, second, or subsequent mixing units include a high shear mixer capable of emulsifying the waste plastic pyrolysis oil and the extract composition. The first separation unit can be capable of receiving the first dispersion or emulsion from the first mixing unit and producing the first raffinate that can include the waste plastic pyrolysis oil. The system can include multiple mixing and separation units (e.g., 3, 4, 5, 6, 7, 8, 9, 10, or more). In some aspects, the mixing units and separation units can be included in a mobile unit. The mixing units can be capable of emulsifying the pyoil with the aqueous extraction solvent to provide high surface area for mass transfer. In some embodiments, the first, second, or subsequent separation units include a hydrophobic membrane (e.g., a tetrafluoroethylene membrane). The hydrophobic membrane can be capable of separating the dispersion (e.g., an emulsion) into the raffinate (e.g., oil phase) and the extract phase (e.g., water phase) by allowing the oil phase to pass through the hydrophobic membrane and rejecting the water phase.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment or aspect discussed herein can be combined with other embodiments or aspects discussed herein and/or implemented with respect to any method or composition of the invention, and vice versa. Furthermore, compositions of the invention can be used to achieve methods of the invention.

The following includes definitions of various terms and phrases used throughout this specification.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight percentage of a component, a volume percentage of a component, or molar percentage of a component, respectively, based on the total weight, the total volume of material, or total moles, which includes the component. In a non-limiting example, 10 grams of component in 100 grams of the material is 10 wt. % of component.

The term “gum,” refers to phased out solid and/or creamy and/or semisolids portion from liquid pyrolysis oil (pyoil). In embodiments of the invention, “gum” can include components having an average molecular weight of 400 Dalton that are soluble or crash out of the solution and/or liquid. Many cracked gasolines, especially those unrefined, a thick resinous material deposited under certain conditions can include gum. For instance, on long standing in dark condition or diffused light condition, it is common that a semi-fluid material, known as “gum”, gradually accumulate as a brown, sticky mass at the bottom of the oil. Another example of “gum” can include a dark brown, hard, and/or resinous residue that can be obtained by evaporation of a liquid product including a cracked gasoline and/or pyoil in a copper dish.

The term “stability,” refers to a pyoil composition is not altered over time by chemical reactions. In embodiments of the invention, “stability” can mean that there is limited or no reactivity of pyoil (treated by an adsorbent) due to cleaning/trapping of reactive substances by the adsorbent. As a result, substantially no or no further formation of gum or any other color changes occurred and properties remained unchanged for a longer period of time after purification.

The term “substantially” and its variations are defined to include ranges within 10%, within 5%, within 1%, or within 0.5%.

15 The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

20 The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The processes of the present invention can “comprise,” “consist essentially of,” or “consist of” particular ingredients, components, compositions, etc. disclosed throughout the specification. With respect to the transitional phrase “consisting essentially of,” in one non-limiting aspect, a basic and novel characteristic of the processes of the present invention are their abilities to lower the amount of contaminants in a waste plastic pyrolysis oil in a cost and/or energy efficient manner using multiple basic extractions with smaller volumes of solvent in successive extractions.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is a schematic of a system for removing contaminants from a waste plastic pyrolysis oil using multiple exaction units of a process of the present invention.

FIGS. 2A and 2B are a schematics of a system for removing contaminants from a waste plastic pyrolysis oil using a high shear extraction unit(s) and a membrane, preferably a hydrophobic membrane, separation(s) of a process of the present invention.

FIG. 3 is a graphical illustration of extraction data for chloride using one embodiment of a process of the present invention using successive extractions by increasing the amount of water in each step by 3% (bottom line). The top line represents single extractions at fixed amounts of water for each extraction.

While the invention is susceptible to various modifications and alternative forms, specific embodiments thereof are shown by way of example in the drawings. The drawings may not be to scale.

### DETAILED DESCRIPTION OF THE INVENTION

Currently, pyoil, especially pyoil derived from pyrolysis of plastics, has a high chloride, organic nitrogen, organic oxygen content and/or gum or gum precursor content. This can be detrimental to the equipment and materials used to store, transport, and/or process pyoil (e.g., lower catalyst life, high gum formation, low stability of the pyoil, and high acidity of the pyoil). Thus, it is highly challenging to store, transport, and/or process pyoil in a chemical plant. As a consequence, pyoil is oftentimes burned for use as fuel in the chemical plant. A discovery has been made that provides at least one solution to one or more of these problems. The process includes successive extracting of waste plastic pyrolysis oil with water or an aqueous containing composition (e.g., at least 50 wt. % water) in increasing increments to reduce the compounds that can poison a catalyst, thus reducing the catalyst's life. In some aspects, the aqueous containing phase can include a base and/or a solvent. The process can also remove gum by removing gum precursors. Thus, the stability of the pyoil can be greatly improved for storage, transportation, and/or further processing. In some aspects, the purified pyoil produced by the process of the present invention can be used to produce recycled (e.g., circular) polymers.

These and other non-limiting aspects of the present invention are discussed in further detail in the following sections with reference to the Figures.

### A. System and Process to Remove Contaminants

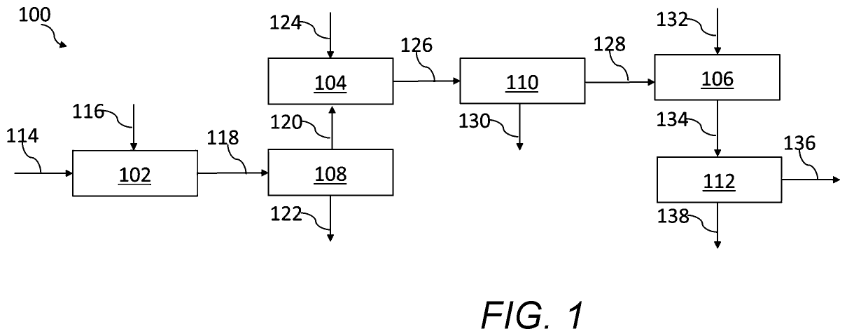

Referring to FIG. 1, system 100 can include first mixing unit 102, second mixing unit 104, third mixing unit 106, first separation unit 108, second separation unit 110, and third separation unit 112. Waste plastic pyrolysis oil 114 and extract composition 116 can enter first mixing unit 102. The waste plastic pyrolysis oil can have a boiling temperature of 20° C. to 500° C. (e.g., 20° C. to 500° C., 40° C. to 450° C., 50° C. to 400° C., 55° C. to 300° C. or any range or value there between). The waste plastic pyrolysis oil can have a molecular weight of 100 g/mol to 500 g/mol, or 100 g/mol, 150 g/mol, 200 g/mol, 250 g/mol, 300 g/mol, 350 g/mol, 400 g/mol, 450 g/mol, 500 g/mol or any value or range there between. The extract composition can include water, base, solvent and/or a mixture thereof. The water can be distilled and/or deionized water. The water can be in the form of an aqueous composition that can include 30 wt. %, 40 wt. %, 50 wt. %, 60 wt. %, 70 wt. %, 80 wt. %, 90 wt. %, 95 wt. %, 96 wt. %, 97 wt. %, 98 wt. %, 99 wt. %, or 100 wt. % water. The water can be substantially free of impurities. For example, the water can have a purity of 90 to 100% or 90%, 91%, 92%, 93%, 94%, 95%, 96%, 97%, 98%, 99%. In some aspects, the extract phase can include 0 to 50 wt. % or less than 50 wt. %, 40 wt. %, 30 wt. %, 20 wt. %, 10 wt. %, 9 wt. %, 8 wt. %, 7 wt. %, 6 wt. %, 5 wt. %, 4 wt. %, 3 wt. %, 2 wt. %, 1 wt. %. 0 wt. % of organic solvents (for example, ethanol, methanol, carboxylic acids, carbonates, amines, and the like). In some aspects, the extract can include 0.1 wt. % to 1 wt. % base.

In first mixing unit 102, waste plastic pyrolysis oil 114 and extract composition 116 can be mixed for a desired period of time (e.g., less than 0.001 minute to 10 minutes) to produce first dispersion 118. Extract composition 116 can include water and a base and/or solvent. First dispersion can include waste plastic pyrolysis oil 114 and extract composition 116. A ratio of waste plastic pyrolysis oil to total water in the extract composition can be 99:1 to 95:5 or 99:1, 98:2, 97:3, 96:4, 95:5 or any ratio, value, or range there between. First dispersion 118 can exit first mixing unit 102 and enter first separation unit 108. In first separation unit 108, first dispersion 118 can be allowed to separate to produce first raffinate 120 and first water extract 122.

First raffinate 120 can exit first separation unit 108 and enter second mixing unit 104. Extract composition 124 can enter second mixing unit 104. An amount of water in extract composition 124 can be increased by 1 to 5 percent or 1 percent, 2 percent, 3 percent, 4 percent, 5 percent, or any value or range there between as compared to the amount of water used in mixing unit 102. Extract composition 124 can also include a base and/or solvent in the same or different than the amounts used in extract composition 116. In some aspects, the base and/or solvent are not added to extract composition 124. For example, if the ratio of waste plastic pyrolysis oil to total water in extract composition 116 is 99:1, the amount of water used in the mixing unit 104 can be increased by 1% to give a ratio of first raffinate 120 to total water in composition 124 of 98:2. In another example, if the ratio of waste plastic pyrolysis oil to water in extraction composition 116 is 95:5, the ratio of first raffinate 120 to total water in extract composition 124 can be 90:10 for a 5% increase in the amount of water used. In second mixing unit 104, first raffinate 120 and extract composition 124 can be mixed for a desired period of time (e.g., milliseconds to 10 minutes) to produce second dispersion 126 which can include first raffinate phase 120 and water phase 124. Second dispersion 126 can exit second mixing unit 104 and enter second separation unit 110. In second separation unit 110, second dispersion 126 can be allowed to separate to produce second raffinate 128 and second water phase 130.

Second raffinate 128 can exit second separation unit 110 and enter third mixing unit 106. Extract composition 132 can enter third mixing unit 106. An amount of total water in extract composition 132 can be increased by 1 to 5 percent or 1 percent, 2 percent, 3 percent, 4 percent, 5 percent, or any value or range there between as compared to the amount of total water used in mixing unit 104. For example, if the ratio of first raffinate 120 to total water in extract composition 124 in mixing unit 104 is 98:2, the ratio of second raffinate 128 to total water in extract composition 132 can be 95:5, which is an increase in the amount of total water by 3%. In third mixing unit 106, second raffinate phase 128 and extract composition 132 can be mixed for a desired period of time (e.g., milliseconds to 10 minutes) to produce third dispersion 134 which can include second raffinate phase 128 and extract composition 132. Third dispersion 134 can exit third mixing unit 106 and enter third separation unit 112. In third separation unit 112, third dispersion 134 can be allowed to separate to produce third raffinate 136 and third water phase 138. Third raffinate 136 can exit third separation unit 112 and be collected transported, stored, or processed in other processing units. First water extract phase 122, second water extract phase 130, and third water extract phase 138 can be recycled, collected, stored, transported, or processed in other units. In some embodiments, the water extract phases are purified (e.g., distillation, ion exchange, adsorbent columns) to remove the contaminates and recycled to mixing units 102, 104 and 106.

The third raffinate 136 can be purified waste plastic pyrolysis oil. The purified waste plastic pyrolysis oil can have at least 10 wt. % less contaminates than the starting waste plastic pyrolysis oil (e.g., waste plastic pyrolysis oil 114). For example, the amount of contaminants can be reduced by 10 wt. %, 11 wt. %, 12 wt. %, 13 wt. %, 14 wt. %, 15 wt. %, or any range or value there between. In a preferred aspect, the reduction in the amount of contaminants can be about 15 wt. %.

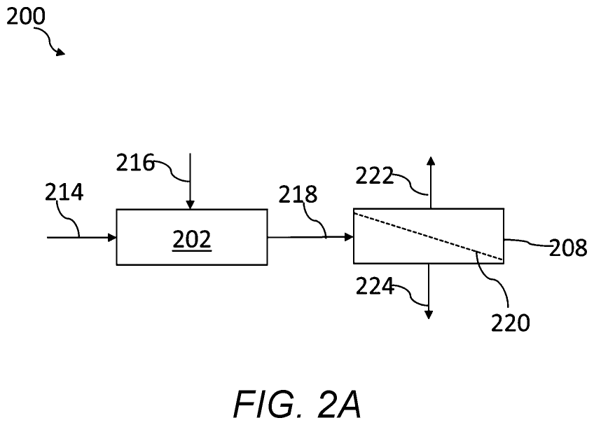

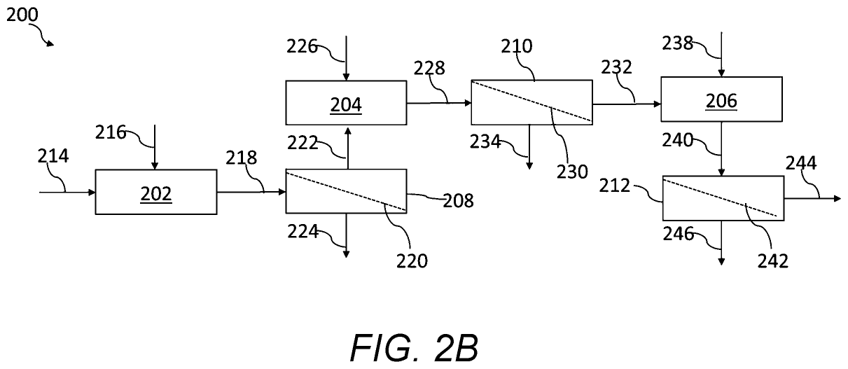

Referring to FIGS. 2A and 2B, system 200 can include first high shear mixing unit 202, second high shear mixing unit 204, third high shear mixing unit 206, first membrane separation unit 208, second membrane separation unit 210, and third membrane separation unit 212. In some embodiments, high shear mixing units 204, 206 and membrane separation units 210 and 212 are not used (shown in FIG. 2A). One or more of the high shear mixing unit can be an in-line mixing unit that can agitate the water/oil mixture sufficient to form an emulsion. In some aspects, more than one in-line mixer can be used upstream of the membrane separation units. Referring to FIG. 2A, waste plastic pyrolysis oil 214 and extract composition 216 can enter first high shear mixing unit 202. The waste plastic pyrolysis oil can have a boiling temperature of 20° C. to 500° C. (e.g., 20° C. to 500° C., 40° C. to 450° C., 50° C. to 400° C., 55° C. to 300° C. or any range or value there between). The waste plastic pyrolysis oil can have a molecular weight of 100 g/mol to 500 g/mol, or 100 g/mol, 150 g/mol, 200 g/mol, 250 g/mol, 300 g/mol, 350 g/mol, 400 g/mol, 450 g/mol, 500 g/mol or any value or range there between. The extract composition can include water, base, solvent and/or a mixture thereof. The water can be distilled and/or deionized water and/or can be in the form of an aqueous composition that can include 30 wt. %, 40 wt. %, 50 wt. %, 60 wt. %, 70 wt. %, 80 wt. %, 90 wt. %, 95 wt. %, 96 wt. %, 97 wt. %, 98 wt. %, 99 wt. %, or 100 wt. % water. The water can be substantially free of impurities. For example, the water can have a purity of 90 to 100% or 90%, 91%, 92%, 93%, 94%, 95%, 96%, 97%, 98%, 99%. In some aspects, the extract phase can include 0 to 50 wt. % 50 wt. %, 40 wt. %, 30 wt. %, 20 wt. %, 10 wt. %, 9 wt. %, 8 wt. %, 7 wt. %, 6 wt. %, 5 wt. %, 4 wt. %, 3 wt. %, 2 wt. %, 1 wt. %. 0 wt. % of organic solvents (for example, ethanol, methanol, carboxylic acids, carbonates, amines, and the like). In some aspects, the extract can include 0.1 wt. % to 1 wt. % base. Non-limiting examples of bases include sodium hydroxide, potassium hydroxide, aluminum hydroxide, calcium hydroxide, or a combination thereof.

In first high shear mixing unit 202, waste plastic pyrolysis oil 214 and extract composition 216 can be agitated at 2,000 to 7,000 rpm (e.g., 2000, 2500, 3000, 3500, 4000, 4500, 5000, 5500, 6000, 6500, 7000 rpm or any value or range there between) for a desired period of time (e.g., less than 0.001 minute to 10 minutes) to produce first emulsion 218. First emulsion 218 can have a residence time in high shear mixing unit 202 of milliseconds (e.g., 1, 5, 10, 20, 30, 40 50 etc. milliseconds). First emulsion 218 can include waste plastic pyrolysis oil 214 and extract composition 216. A ratio of waste plastic pyrolysis oil to total water in the extract composition can be 99:1 to 95:5 or 99:1, 98:2, 97:3, 96:4, 95:5 or any ratio, value, or range there between. First emulsion 218 can exit first high shear mixing unit 202 and enter first hydrophobic membrane separation unit 208. In first membrane separation unit 208, the non-aqueous portion of first emulsion 218 can pass through membrane 220 to produce first raffinate 222 and the aqueous portion of the first emulsion can be rejected by the hydrophobic membrane to produce first water extract 224. First raffinate 222 can exit first membrane separation unit 208 and be sold, transported, or sent to further processing units, if the impurity level is at an acceptable level. In some aspects, the raffinate 222 can be purified waste plastic pyrolysis oil. The purified waste plastic pyrolysis oil can have at least 10 wt. % less contaminates than the starting waste plastic pyrolysis oil (e.g., waste plastic pyrolysis oil 214). For example, the amount of contaminants can be reduced by 10 wt. %, 11 wt. %, 12 wt. %, 13 wt. %, 14 wt. %, 15 wt. %, or any range or value there between. In a preferred aspect, the reduction in the amount of contaminants can be about 15 wt. %.

Referring to FIG. 2B, first raffinate 222 exits first membrane separation unit 208 and enters second high shear mixing unit 204. Extract composition 226 can enter second high shear mixing unit 204. An amount of water in extract composition 226 can be increased by 1 to 5 percent or 1 percent, 2 percent, 3 percent, 4 percent, 5 percent, or any value or range there between as compared to the amount of water used in high shear mixing unit 202. Extract composition 226 can also include a base and/or solvent in the same or different than the amounts used in extract composition 216. In some aspects, a base and/or solvent are not added to extract composition 226. For example, if the ratio of waste plastic pyrolysis oil to total water in extract composition 216 is 99:1, the amount of water used in the high shear mixing unit 204 can be increased by 1% to give a ratio of first raffinate 222 to total water in composition 226 of 98:2. In another example, if the ratio of waste plastic pyrolysis oil to water in extraction composition 216 is 95:5, the ratio of first raffinate 222 to total water in extract composition 226 can be 90:10 for a 5% increase in the amount of water used. In second high mixing unit 204, first raffinate 220 and extract composition 226 can be mixed at 2,000 to 7,000 rpm (e.g., 2000, 2500, 3000, 3500, 4000, 4500, 5000, 5500, 6000, 6500, 7000 rpm or any value or range there between) for a desired period of time (e.g., less than 0.001 minute to 10 minutes) to produce second emulsion 228. Second emulsion 228 can have a residence time in high shear mixing unit 204 of milliseconds (e.g., 1, 5, 10, 20, 30, 40 50 etc. milliseconds). Second emulsion 228 can exit second high shear mixing unit 204 and enter second membrane separation unit 210. In second membrane separation unit 218, the non-aqueous portion of second emulsion 228 can pass through membrane 230 to produce first raffinate 232 (oil rich phase) and the aqueous portion of the second emulsion can be rejected by the hydrophobic membrane to produce second water extract 234.

Second raffinate 232 can exit second membrane separation unit 210 and be sold, transported, further processed or a combination thereof depending on the level of impurities. As shown in FIG. 2B, second raffinate 232 enters third high shear mixing unit 206. Extract composition 238 can enter third high shear mixing unit 206. An amount of total water in extract composition 238 can be increased by 1 to 5 percent or 1 percent, 2 percent, 3 percent, 4 percent, 5 percent, or any value or range there between as compared to the amount of total water used in mixing unit 204 as previously described in FIG. 1. In third mixing unit 206, second raffinate 232 and extract composition 238 can be mixed for can be mixed at 2,000 to 7,000 rpm (e.g., 2000, 2500, 3000, 3500, 4000, 4500, 5000, 5500, 6000, 6500, 7000 rpm or any value or range there between) for a desired period of time (e.g., less than 0.001 minute to 10 minutes) to produce third emulsion 240, which can include second raffinate 232 and extract composition 238. Third emulsion 240 can exit third high shear mixing unit 206 and enter third membrane separation unit 212. In third hydrophobic membrane separation unit 212, the non-aqueous portion of third emulsion 240 can pass through hydrophobic membrane 242 to produce third raffinate 244 and the aqueous portion of the third emulsion can be rejected by the hydrophobic membrane to produce third water phase 246. Third raffinate 244 can exit third membrane separation unit 212 and be collected transported, stored, or processed in other processing units. First water extract phase 224, second water extract phase 234, and third water extract phase 246 can be recycled, collected, stored, transported, or processed in other units. In some embodiments, the water extract phases are purified (e.g., distillation, ion exchange, adsorbent columns) to remove the contaminates and recycled to mixing units 202, 204 and 206.

The raffinates (e.g., raffinates 232 and 244) can be purified waste plastic pyrolysis oil. The purified waste plastic pyrolysis oil can have at least 10 wt. % less contaminates than the starting waste plastic pyrolysis oil (e.g., waste plastic pyrolysis oil 214). For example, the amount of contaminants can be reduced by 10 wt. %, 11 wt. %, 12 wt. %, 13 wt. %, 14 wt. %, 15 wt. %, or any range or value there between. In a preferred aspect, the reduction in the amount of contaminants can be about 15 wt. %.

Contaminants can include chloride containing compounds, organic nitrogen containing compounds, oxygenates (compounds other than water) and the like. Non-limiting examples of chloride containing compounds can include 1,2-dichloroethane, 2-chloroethanol acetate; 2-chloroethanol; 2-(2-chloroethoxy) ethanol; 2-chloroethoxy benzene; 1,2 dichloroethene; 1-chloro-2-ethyoxyethane; 2-chloroethylmethylsulfide; 2,3-dichloro-1-propanol; 1,3-dichloro-2-propanol; 1,4-dichlorobutane, bis(2-chloroethyl)-ether; 2-chloroethylbenzoate; etc. or a combination thereof.

Non-limiting examples of oxygen and/or nitrogen containing compounds can include aliphatic acids, aromatic acids, nitriles, amines, aldehydes, aliphatic/cyclic ketones, cyclic amides, aliphatic/aromatic alcohols, diols, esters, ethers, aliphatic/cyclic chlorines, furans, indoles, quinolines, phenolic compound, indolic compounds, acidic compounds, alcohols, amines, or combinations thereof. The oxygen and/or nitrogen containing compounds can include 2-heptadecanone, 2-pentanone, caprolactam, 3-heptanol, methyl (iso2), octadecanenitrile, oleanitrile, cyclopentanone, traidecanenitrile, heptanoic acid, doedecanophenone, 2-cyclopentenol, 1-butanol, benzoic acid, hexanenitrile, tridecanenitrile, 2-cyclopenten-1-one, 2-hydroxy-3-m, phenol, Cs substituted (iso2), 2-cyclopenten-1-one, 3-ethyl-2-hydro, or a combination thereof.

Systems 100 and 200 can include one or more heating and/or cooling devices (e.g., insulation, electrical heaters, jacketed heat exchangers in the wall) or controllers (e.g., computers, flow valves, automated values, etc.) that can be used to control the reaction temperature and pressure of the mixing units. While only 3 mixing units or separation units are shown, it should be understood that more than 3 mixing and separation units can be used. Mixing can be performed using known mixing methods (e.g., agitation, shaking, centrifugation, and the like). In some embodiments, supercritical extraction is used. Extraction (e.g., mixing) temperatures in the mixing units of Systems 100 and 200 can be 20° C. to 150° C. For example, 20° C., 30° C., 40° C., 50° C., 60° C., 70° C., 80° C., 100° C., 110° C., 150° C., or any range or value there between. Separation temperatures in the separation units of System 100 can range from 20° C. to 250° C. For example, settling temperatures can be 20° C., 30° C., 40° C., 50° C., 60° C., 70° C., 80° C., 90° C., 100° C., 125° C., 150° C., 175° C., 200° C., 225° C., 250° C. or any value or range there between. The temperature, pressure, and GHSV can be varied and is within the skill of a person performing the reaction (e.g., an engineer or chemist). Separation units of System 100 can be any unit capable of allowing separation of two phases (e.g., settling tanks, coalescers, or combinations thereof). Non-limiting examples of high shear mixers in System 200 can include HSM high-shear mixers and Silversone high-shear mixers. A non-limiting example of a hydrophobic membrane in membrane separation unit of System 200 can include polytetrafluoroethylene membrane. Temperatures in the separation units of System 200 can range from 20° C. to 175° C. For example, temperatures can be 20° C., 30° C., 40° C., 50° C., 60° C., 70° C., 80° C., 90° C., 100° C., 125° C., 150° C., 175° C., or any value or range there between in the membrane separation unit(s).

### EXAMPLES

The present invention will be described in greater detail by way of specific examples. The following examples are offered for illustrative purposes only and are not intended to limit the invention in any manner. Those of skill in the art will readily recognize a variety of noncritical parameters which can be changed or modified to yield essentially the same results.

### Example 1

### Extraction of Waste Plastic Pyrolysis Oil

Waste plastic pyrolysis oil (500 mL having a boiling range of 30 to 450° C. and a molecular weight of 30 to 300 mol/g) and water 15 mL was placed in a stirred reactor and mixed for 10 at 450 rpm. The resulting dispersion was transferred to a decanter and let stand until the phases separated. The raffinate (450 mL) was removed and placed in a stirred reactor. Water (13.5 mL) was added to the stirred reactor and the solution was mixed for 10 at 450 rpm. The amount of water was increased by 3%. The resulting dispersion was transferred to a decanter and let stand for 1 minute until the phases separated. The process was repeated four more times. The amount of organic chloride decreased from 233.6 to 144 ppm after the third extraction.

### Comparative Example 1

### Extraction of Waste Plastic Pyrolysis Oil at Specified Weight Ratio

Waste plastic pyrolysis oil (50 mL) and water 1.5 mL was placed in a stirred reactor and mixed for 10 at 450 rpm. The resulting dispersion was transferred to a decanter and let stand for 1 minute until the phases separated. The decrease in the amount of organic chloride was not as much as the process of the present invention. The amounts of chloride present using a ratio of pyoil to water of 97:3 was 176 ppm.

### Comparative Example 2

### Extraction of Waste Plastic Pyrolysis Oil at Specified Weight Ratio

Waste plastic pyrolysis oil (50 mL) and water 4.5 mL was placed in a stirred reactor and mixed for 10 at 450 rpm. The resulting dispersion was transferred to a decanter and let stand for 1 minute until the phases separated. The decrease in the amount of organic chloride was not as much as the process of the present invention. The amounts of chloride present using a ratio of pyoil to water of 91:9 was 156 ppm.

### Comparative Example 3

### Extraction of Waste Plastic Pyrolysis Oil at Specified Weight Ratio

Waste plastic pyrolysis oil (50 mL) and water 9 mL was placed in a stirred reactor and mixed for 10 at 450 rpm. The resulting dispersion was transferred to a decanter and let stand for 1 minute until the phases separated. The decrease in the amount of organic chloride was not as much as the process of the present invention. The amounts of chloride present using a ratio of pyoil to water of 82:18 was 144 ppm.

### Comparative Example 4

### Extraction of Waste Plastic Pyrolysis Oil at Specified Weight Ratio

Waste plastic pyrolysis oil (50 mL) and water 10.5 mL was placed in a stirred reactor and mixed for 10 at 450 rpm. The resulting dispersion was transferred to a decanter and let stand for 1 minute until the phases separated. The decrease in the amount of organic chloride was not as much as the process of the present invention. The amounts of chloride present using a ratio of pyoil to water of 79:21 was 141.8 ppm.

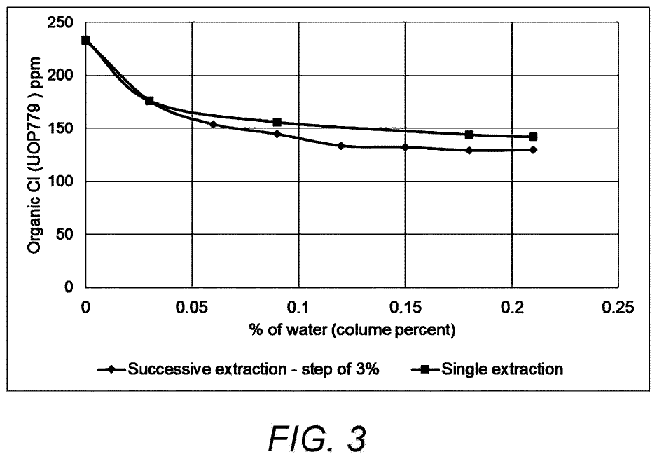

Table 1 lists the data for the repeated extractions (Example 1) and the comparative Examples 1 to 4. FIG. 3 is an illustration of this data.

TABLE 1

| | Water | Pyoil | Water | UOP770 |
|---|---|---|---|---|
| Example # | % | (mL) | (mL) | (Cl ppm) |
| Blank 450 rpm at 10 min | 0 | 50 | | 233.6 |
| 1 | 3% | 500 | 15 | 176 |
| 1 | 6% | 450 | 13.5 | 153.8 |
| 1 | 9% | 400 | 12 | 144.4 |
| 1 | 12% | 350 | 10.5 | 133.3 |
| 1 | 15% | 300 | 9 | 132.1 |
| 1 | 18% | 250 | 7.5 | 129 |
| 1 | 21% | 200 | 6 | 129.5 |
| Comparative Example 1 | 3% | 50 | 1.5 | 176 |
| Comparative Example 2 | 9% | 50 | 4.5 | 156 |
| Comparative Example 3 | 18% | 50 | 9 | 144 |
| Comparative Example 4 | 21% | 50 | 10.5 | 141.8 |

### Example 2

### Extraction of Waste Plastic Pyrolysis Oil with Aqueous Base

Waste plastic pyrolysis oil (125 mL having a boiling range of 30° C. to 450° C. and a molecular weight of 30 to 300 mol/g) and water 125 mL and base 0.1 wt. % was shaken in a vial until the phases were mixed. The resulting dispersion was allowed to stand until the phases separated. The raffinate (118 mL) was removed and analyzed. The removal of organic chloride was increased by 18% over a water extraction without base using the same amount of pyrolysis oil and water.

In the context of the present invention, at least the following 15 embodiments are described. Embodiment 1 is a process to remove contaminants from a waste plastic pyrolysis oil. The process includes (a) extracting a waste plastic pyrolysis oil composition including waste plastic pyrolysis oil and contaminants with a first extract composition including water and an optional base to produce a first raffinate including the waste plastic pyrolysis oil and having less contaminates than the waste plastic pyrolysis oil composition before extraction, and wherein a volume ratio of the waste plastic pyrolysis oil to water in the first extract composition is 99:1, preferably 95:5; and (b) extracting the first raffinate from step (a) with a second extract composition including water and an optional base to produce a second raffinate including the first raffinate and having less contaminates than the first raffinate before extraction, and wherein a volume ratio of the first raffinate to water in the second extract composition is 98:2 or less, preferably 90:10; and (c) repeating the extraction of step (b) at least 2 times, preferably 3 times, more preferably 5 times, wherein the amount of water in each extract composition used in step (b) for each extraction is increased by 1 percent to 5 percent, preferably 3 percent for each subsequent extraction, based on the total volume; and wherein, in each extraction, the contaminate content of the subsequent raffinate is reduced as compared to the contaminate content of the previous raffinate of step (b). Embodiment 2 is the process of embodiment 1, wherein each extract composition include a base, and at least one extract composition further includes a polar solvent, preferably an alcohol. Embodiment 3 is the process of any one of embodiments 1 to 2, wherein the base includes sodium hydroxide, potassium hydroxide, calcium hydroxide, aluminum hydroxide or a combination thereof.

Embodiment 4 is the process of any one of embodiments 1 to 2, further including ending the extraction and collecting the final raffinate including purified oil phase, wherein the contaminate content of the final raffinate including pyrolysis oil is reduced as compared to the contaminate content of the waste plastic pyrolysis oil of step (a). Embodiment 5 is the process of any one of embodiments 1 to 2, wherein each extraction includes the step of separating the raffinate from the extract composition including water; and collecting the separated extract composition from each extraction. Embodiment 6 is the process of any one of embodiments 1 to 2, wherein in step (a) extracting includes emulsifying the pyoil with the first extract including water and optional base. Embodiment 7 is the process of embodiment 6, and each extraction includes separating the emulsion in a hydrophobic membrane, preferably a polytetrafluoroethylene membrane to produce a raffinate, and optionally step (b) and step (c) are not performed. Embodiment 8 is the process of any one of embodiments 1 to 2, wherein an extraction temperature is 20° C. to 150° C. and wherein extraction includes allowing the raffinate to separate from the extract composition at a temperature of 20° C. to 250° C. Embodiment 9 is the process of any one of embodiments 1 to 2, wherein the contaminate includes chloride compounds, preferably organic chlorides and the chloride content is reduced by at least 10 wt. %, preferably 15 wt. %. Embodiment 10 is the process of embodiment 9, wherein the organic chlorides include 1,2-dichloroethane, 2-chloroethanol acetate; 2-chloroethanol; 2-(2-chloroethoxy) ethanol; 2-chloroethoxy benzene; 1,2 dichloroethene; 1-chloro-2-ethyoxyethane; 2-chloroethylmethylsulfide; 2,3-dichloro-1-propanol; 1,3-dichloro-2-propanol; 1,4-dichlorobutane, bis(2-chloroethyl)-ether; 2-chloroethylbenzoate; or a combination thereof. Embodiment 11 is the process of any one of embodiments 1 to 2, wherein the contaminates further include oxygenates and extraction lowers the oxygenate by at least 10 wt. %, preferably 15 wt. %, wherein the contaminates further include organic nitrogen compounds and extraction lowers the total organic nitrogen content by at least 10 wt. %, preferably 15 wt. %. Embodiment 12 is the process of any one of embodiments 1 to 2, wherein the contaminates are gum or gum-producing precursors. Embodiment 13 is the process of any one of embodiments 1 to 2, wherein the contaminate content is lowered compared to multiple extractions at a constant ratio of raffinate to water.

Embodiment 14 is a system for reducing contaminants in a waste plastic pyrolysis oil using the process of any one of embodiments 1 to 2, the system including: a first mixing unit capable of receiving waste plastic pyrolysis oil and the first extract composition including water and a base, and producing a first dispersion including the waste plastic pyrolysis oil and the extract composition; a first separation unit in fluid communication with the first mixing unit, the first separation unit capable of receiving the first dispersion from the first mixing unit, the first separation unit capable of producing the first raffinate including the waste plastic pyrolysis oil; a second mixing unit in fluid communication with the first separation unit and capable of receiving the first raffinate and the second extract composition and producing a second dispersion including the first raffinate and the second extract composition; and a second separation unit in fluid communication with the second mixing unit, the second separation unit capable of receiving the second dispersion from the second mixing unit, the second separation unit capable of producing a second raffinate including waste plastic pyrolysis oil having less contaminates as the waste plastic pyrolysis oil prior to the second extraction. Embodiment 5 is the system of embodiment 14, further including a third, fourth, fifth and more mixing units in fluid contact with respective separation units, wherein: the mixing units and separation units are included in a mobile unit; at least one of the mixing units includes a high-speed mixer capable of emulsifying the dispersion; at least one of the separation units includes a hydrophobic membrane, preferably a polytetrafluoroethylene membrane capable of separating the raffinate(s) from the extract(s); or a combination thereof.

Although embodiments of the present application and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A process to remove contaminants from a waste plastic pyrolysis oil, the process comprising:
(a) extracting a waste plastic pyrolysis oil composition comprising waste plastic pyrolysis oil and contaminants with a first extract composition comprising water and an optional base to produce a first raffinate comprising the waste plastic pyrolysis oil and having less contaminates than the waste plastic pyrolysis oil composition before extraction, and wherein a volume ratio of the waste plastic pyrolysis oil to water in the first extract composition is 99:1 to 95:5; and
(b) extracting the first raffinate from step (a) with a second extract composition comprising water and an optional base to produce a second raffinate comprising the first raffinate and having less contaminates than the first raffinate before extraction, and wherein a volume ratio of the first raffinate to water in the second extract composition is 98:2 or less; and
(c) repeating the extraction of step (b) at least 2 times, wherein the amount of water in each extract composition used in step (b) for each extraction is increased by 1 percent to 5 percent for each subsequent extraction, based on the total volume; and
wherein, in each extraction, the contaminate content of the subsequent raffinate is reduced as compared to the contaminate content of the previous raffinate of step (b).

2. The process of claim 1, wherein each extract composition comprises a base, and at least one extract composition further comprises a polar solvent.

3. The process of claim 1, wherein the base comprises sodium hydroxide, potassium hydroxide, calcium hydroxide, aluminum hydroxide or a combination thereof.

4. The process of claim 1, further comprising ending the extraction and collecting the final raffinate comprising purified oil phase, wherein the contaminate content of the final raffinate comprising pyrolysis oil is reduced as compared to the contaminate content of the waste plastic pyrolysis oil of step (a).

5. The process of claim 1, wherein each extraction comprises separating the raffinate from the extract composition comprising water; and
collecting the separated extract composition from each extraction.

6. The process of claim 1, wherein in step (a) extracting comprises emulsifying the pyoil with the first extract comprising water and optional base.

7. The process of claim 6, wherein each extraction comprises separating the emulsion in a hydrophobic membrane to produce a raffinate, and optionally step (b) and step (c) are not performed.

8. The process of claim 1, wherein an extraction temperature is 20° C. to 150° C. and wherein extraction comprises allowing the raffinate to separate from the extract composition at a temperature of 20° C. to 250° C.

9. The process of claim 1, wherein the contaminate comprises chloride compounds and the chloride content is reduced by at least 10 wt. %.

10. The process of claim 9, wherein the organic chlorides comprise 1,2-dichloroethane, 2-chloroethanol acetate; 2-chloroethanol; 2-(2-chloroethoxy) ethanol; 2-chloroethoxy benzene; 1,2 dichloroethene; 1-chloro-2-ethyoxyethane; 2-chloroethylmethylsulfide; 2,3-dichloro-1-propanol; 1,3-dichloro-2-propanol; 1,4-dichlorobutane, bis(2-chloroethyl)-ether; 2-chloroethylbenzoate; or a combination thereof.

11. The process of claim 1, wherein the contaminates further comprise oxygenates and extraction lowers the oxygenate by at least 10 wt. %, wherein the contaminates further comprise organic nitrogen compounds and extraction lowers the total organic nitrogen content by at least 10 wt. %.

12. The process of claim 1, wherein the contaminates are gum or gum-producing precursors.

13. The process of claim 1, wherein the contaminate content is lowered compared to multiple extractions at a constant ratio of raffinate to water.

14. A system for reducing contaminants in a waste plastic pyrolysis oil using the process of claim 1, the system comprising:
a first mixing unit capable of receiving waste plastic pyrolysis oil and the first extract composition comprising water and a base, and producing a first dispersion comprising the waste plastic pyrolysis oil and the extract composition;
a first separation unit in fluid communication with the first mixing unit, the first separation unit capable of receiving the first dispersion from the first mixing unit, the first separation unit capable of producing the first raffinate comprising the waste plastic pyrolysis oil;
a second mixing unit in fluid communication with the first separation unit and capable of receiving the first raffinate and the second extract composition and producing a second dispersion comprising the first raffinate and the second extract composition; and
a second separation unit in fluid communication with the second mixing unit, the second separation unit capable of receiving the second dispersion from the second mixing unit, the second separation unit capable of producing a second raffinate comprising waste plastic pyrolysis oil having less contaminates as the waste plastic pyrolysis oil prior to the second extraction.

15. The system of claim 14, further comprising a third, fourth, fifth and more mixing units in fluid contact with respective separation units, wherein: the mixing units and separation units are comprised in a mobile unit; at least one of the mixing units comprises a high-speed mixer capable of emulsifying the dispersion; at least one of the separation units comprises a hydrophobic membrane capable of separating the raffinate(s) from the extract(s); or a combination thereof.

16. The process of claim 1, wherein the volume ratio of the waste plastic pyrolysis oil to water in the first extract composition is 95:5; and the volume ratio of the first raffinate to water in the second extract composition is 90:10.

17. The process of claim 7, wherein the hydrophobic membrane is a polytetrafluoroethylene membrane.
